(19) United States
(12) Patent Application Publication
(10) Pub. No.: US 2007/0268149 A1
(43) Pub. Date: Nov. 22, 2007

(54) Structure of reformed traffic light

(76) Inventor: I-Ching Chen, I Lan City (TW)

Correspondence Address: BIRCH STEWART KOLASCH & BIRCH, PO BOX 747, FALLS CHURCH, VA, 22040-0747, US

(21) Appl. No.: 11/434,237

(22) Filed: May 16, 2006

(51) Int. Cl. G09F 9/33; G08G 1/095

(52) U.S. Cl. 340/815.45; 340/907

(57) ABSTRACT

This invention relates to a “structure of reformed traffic light”, comprising of a signal box enclosing at least one set of light sources arrayed in square or round matrix. It features a set of light source adopting Light Emitting Diodes (LED) as lamps and each LED contains at least red and green semi-conductor chips (hereinafter abbreviated as chip) to emit red, green and amber lights. Furthermore, it is the traffic control signals that control the lights. By applying the foregoing features, an all-in-one traffic light is invented with advantages such as lighter weight, reduced dimensions and cost effectiveness for installation, repair and maintenance in comparison with the existing traffic lights.

### BACKGROUND OF THE INVENTION

I. Field of the Invention

This invention refers to a “structure of reformed traffic light”, and more particularly, to a single light box enclosing a set of light sources. Each lamp contained in the set of light sources comprises a control circuit and red, green and blue chips that allow the single light box to beam red, green or amber light. The foregoing features reveal a design of all-in-one traffic light that reduces the manufacturing cost.

II. Description of the Prior Art

With reference to the structure of existing tricolored traffic lights with red, amber and green lights, it is constructed with one light box enclosing three sets of light sources or, three light boxes with each enclosing a light to control the traffics. Besides, the set of light sources enclosed therein usually adopts tungsten-filament lamps or LED lights.

Per the aforesaid descriptions, the structure of existing traffic lights must have a beam to affix the light box for red, amber and green lights (as per FIG. 6) in minimum and listed below are the disadvantages:
1. Higher cost—In terms of quantity, solidity and weight of the light box, it is only a beam with commensurate structure that can hang the light box.
2. Higher risk of damage by winds—Various areas are frequently struck by typhoons and large surfaces are hit by strong winds during typhoon seasons. Consequently, the existing traffic lights cannot be let off because its large dimensions cause higher resistance to winds.
3. Unsighted—The erective traffic lights (as per FIG. 7), which have large dimensions, are easy to hinder the sight of drivers and increase danger of driving while being installed in the intersection of roads.

In view of the aforesaid disadvantages, an innovative “structure of reformed traffic light” is thus invented.

Objective of this invention is to provide a “structure of reformed traffic light” that is easy in installation, light in weight and effective in cost. It is an all-in-one design that benefits traffic authorities, drivers and pedestrians.

### SUMMARY OF THE INVENTION

To achieve the foregoing objective, this invention of a “structure of reformed traffic light”, comprising of a signal box and enclosing at least one set of light sources arrayed in square or round matrix. Furthermore, the set of light sources feature LEDs containing at least red and green chips to emit lights of red, green and amber. It is enough to have red and green chips for red, green and amber light as amber light is the mix of red and green lights.

Through combining the aforesaid structures, the reformed traffic light is constructed as an all-in-one equipment controlled by traffic control signals to beam red, amber or green light or other special signals. Advantages of which are as follow:
1. Lower cost—Reformed traffic lights of this invention is compact in dimensions and light in weight through integrating various light signals into one set of light sources. Consequently, it requires less materials and cost for installation.
2. Lower risk of damage by winds—Reformed traffic lights of this invention has lower risk of being damaged by winds during typhoon seasons because its compact dimensions and light weight have lower resistance to winds.
3. Clear sight—The erective traffic lights adopt the structure of reformed traffic lights and can reduce dimensions to two-third of original ones and provide drivers of broader vision to assure safety in driving while being installed in the intersection of roads.

### BRIEF DESCRIPTION OF THE DRAWINGS

FIG. 1 is the diagram of this invention.

FIG. 2 is the embodiment of LED in the set of light sources of this invention.

FIG. 3 is front view of this invention hanged by side.

FIG. 4 is vertical view of this invention hanged by side.

FIG. 5 is front view of this invention in erective model.

FIG. 6 is the diagram of existing horizontal tri-colored traffic lights.

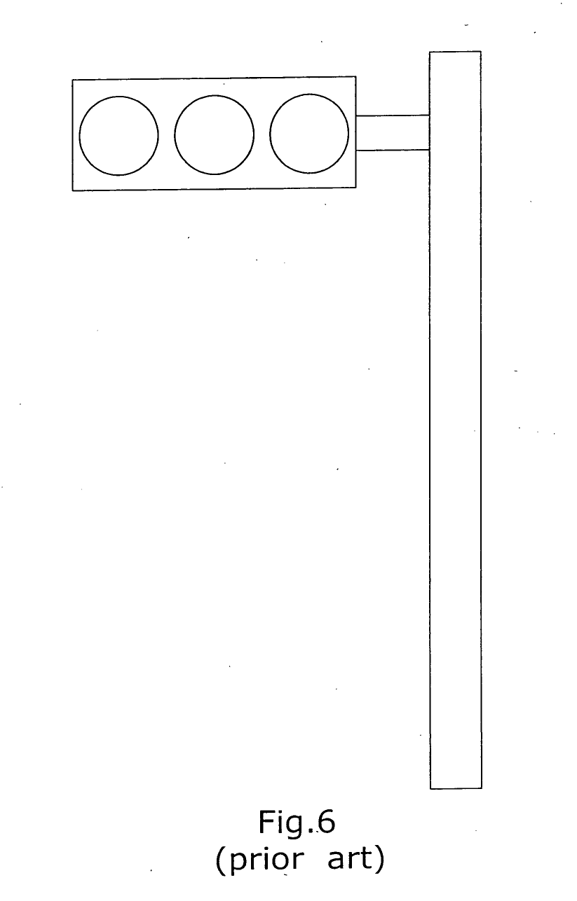

FIG. 7 is the diagram of existing vertical tri-colored traffic lights.

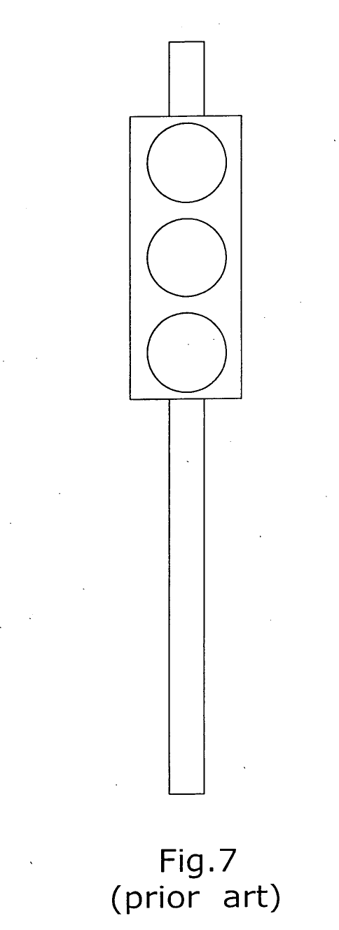

### DESCRIPTION OF THE PREFERRED EMBODIMENT

Further structure, features and functions of this invention will be better understood from the detailed description and drawings that follow a better embodiment of the disclosed invention are illustrated by ways of example below:

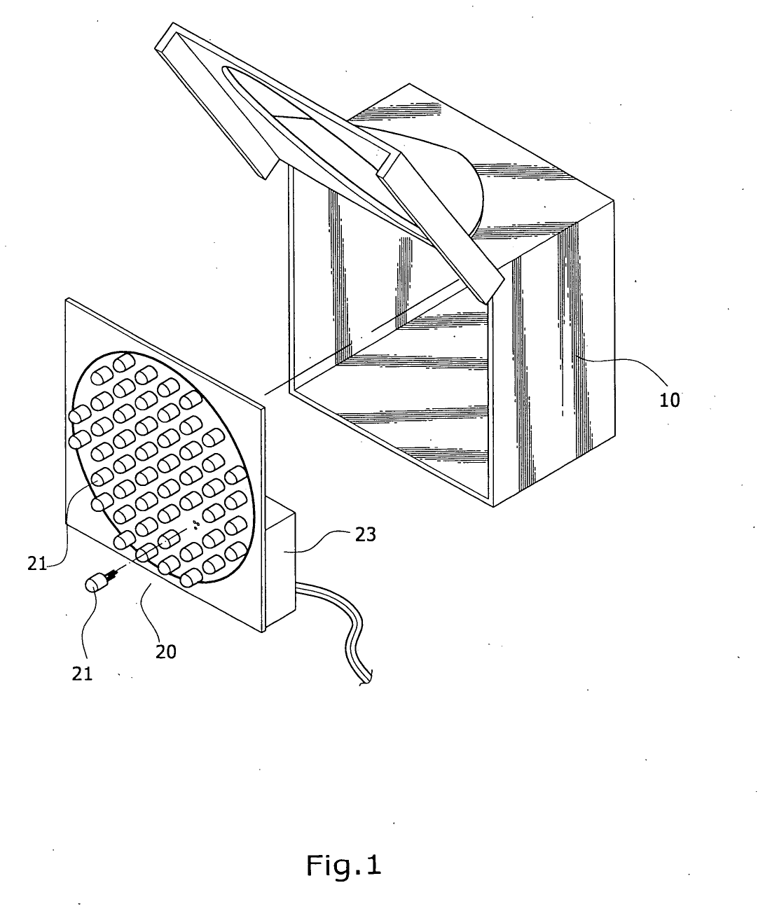

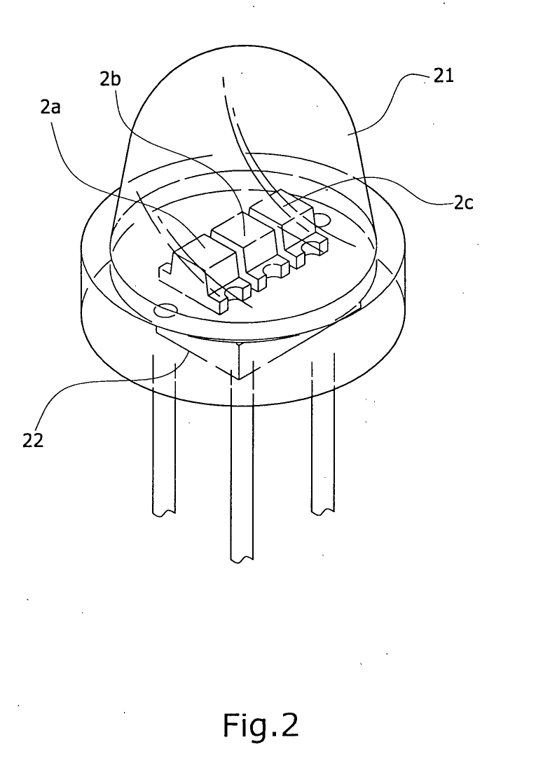

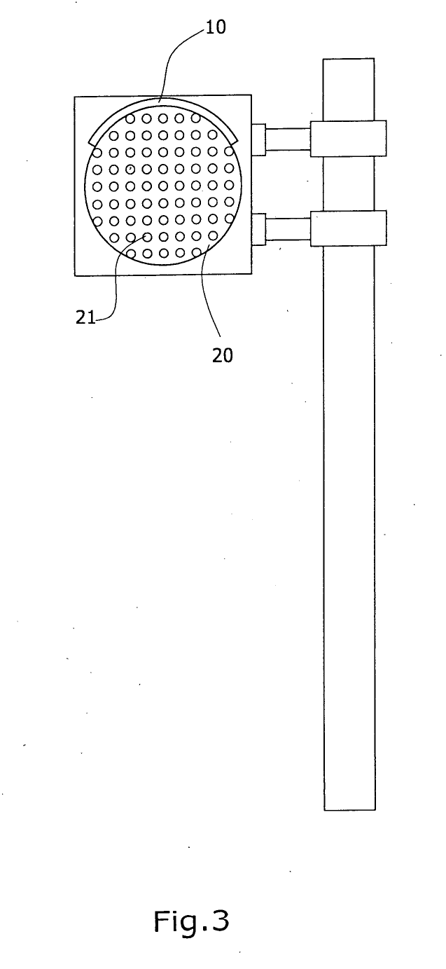

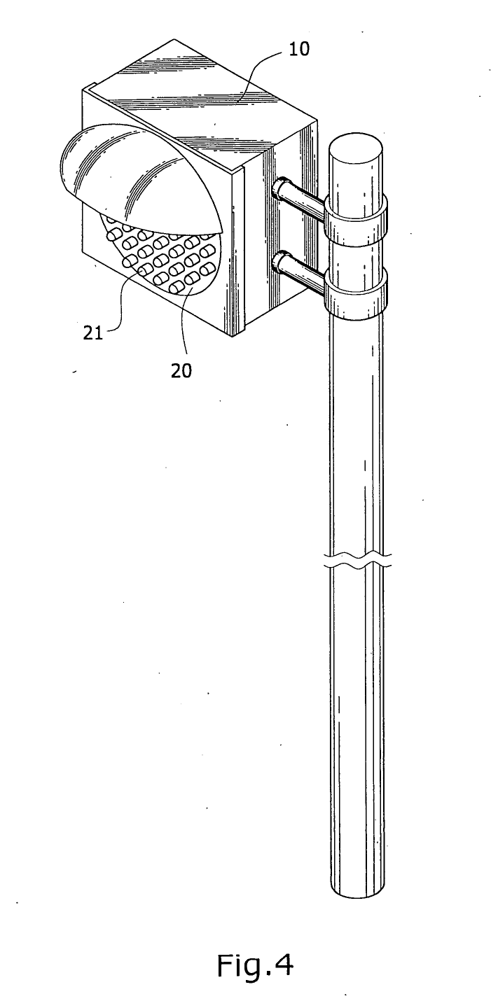

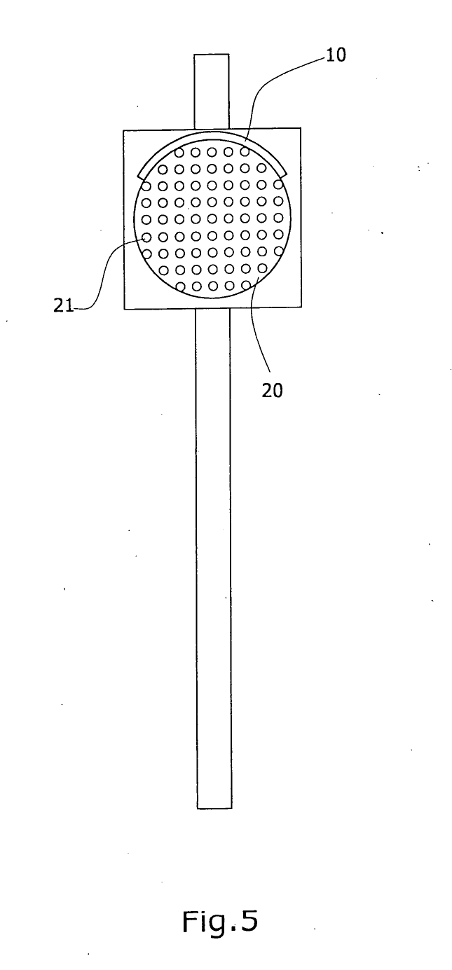

Referring to FIG. 1 to 5, the “structure of reformed traffic lights” comprises of a signal box 10 enclosing at least one set of light sources 20 arrayed in square or round matrix. Each lamp 21 in the set of light sources 20 is a LED (i.e. multicolored LED). However, embodiment of the disclosed invention adopts LED that is composed of red 2a, green 2b and blue 2c chips (as per FIG. 2).

With reference to the foregoing structure, red 2a, green 2b and blue 2c chips of LED 21 each can be driven internally by its embedded driver chip 22 or externally by a light control circuit 23 to beam lights of red, green, amber or other colors. Consequently, this set of light sources 20 can beam red, amber and green lights and, further, direction signals of special colors or patterns (e.g. arrow). The foregoing multiple functions reveal that the structure of reformed traffic light commits to higher practicability and economic value.

Further, embodiment of this invention adopts red and green chips in each LED 21 in view that the traffic lights usually require red, green and amber lights and amber light is a mix of red and green light.

Through combining the foregoing structures, the reformed traffic lights is constructed as an all-in-one equipment that can be controlled by traffic control signals to beam red, amber or green light and other special signals (e.g. arrow for direction). Advantages of which are as follow:
1. Lower cost—Reformed traffic light of this invention is compact in dimensions and light in weight because it uses one set of light sources enclosed in the signal box to perform various lights and signals. Consequently, it requires less materials and cost for installation.
2. Lower risk of damage by winds—Reformed traffic light of this invention has lower risk of being damaged by winds during typhoon seasons because its compact dimensions and light weight have lower resistance to winds.
3. Clear sight—The erective traffic lights adopt the structure of reformed traffic lights are able to reduce dimensions to two-third of original ones and shall provide drivers of broader vision to assure safety in driving while being installed in the intersection of roads.

In summary, the “structure of reformed traffic lights” disclosed by this invention substantively reduces installation cost and elevates effectiveness of use. Further, characteristics of this invention have not been released in any publication or used in the public prior to patent registration. Therefore, submission of this invention is to register the patent for its original design according to the patent law.

1. A “structure of reformed traffic light” mainly comprises of a signal box enclosing at least one set of light sources arrayed in square or round matrix. It features that each lamp in the set of light sources is variable in lights for beaming red, green or amber lights.

2. The “structure of reformed traffic lights” of claim 1, wherein each lamp is a LED containing at least red and green chips.

3. The “structure of reformed traffic lights” of claim 1, wherein each LED containing red, green and blue chips to beam lights of red, amber, green or other colors.

4. The “structure of reformed traffic lights” of claim 2, wherein each chip contained in the LED is internally driven by its embedded driver chip to emit lights of red, amber, green or other colors.

5. The “structure of reformed traffic lights” of claim 2, wherein each chip contained in the LED is externally driven by a light control circuit to emit lights of red, amber, green or other colors.
